(19) United States
(12) Patent Application Publication
(10) Pub. No.: US 2019/0377766 A1
(43) Pub. Date: Dec. 12, 2019

(54) WEB ACCESS ENHANCEMENT

(71) Applicant: VE GLOBAL UK LIMITED, London (GB)

(72) Inventor: Matthew BULL, London (GB)

(21) Appl. No.: 16/472,352

(22) PCT Filed: Dec. 22, 2017
(86) PCT No.: PCT/EP2017/084387

§ 371 Date: Jun. 21, 2019

(30) Foreign Application Priority Data
Dec. 22, 2016 (GB) 1621976.8

(51) Int. Cl. G06F 16/958; G06F 9/445; G06F 16/957

(52) U.S. Cl. CPC G06F 16/958; G06F 16/9574; G06F 9/445

(57) ABSTRACT

There is provided a method, and associated computer device, for controlling activation of a software application associated with a web page on closure of the web page, comprising: determining if another linked web page is associated with the software application; and in dependence thereon selectively enabling the software application.

### BACKGROUND TO THE INVENTION

### Field of the Invention

The present invention relates to an arrangement in which a software application is provided in conjunction with a user accessible website to enhance services provided by the user accessible website to the user. The software application may be provided by a 3^{rd} party, and be a 3^{rd} party software application. The invention is particularly concerned with detection of closure of a web page in a user's journey which is the last web page in that journey associated with such a software application or the functionality of such a software application.

### Description of the Related Art

In a computer network, user computing devices may access websites associated with web applications hosted by web servers. The websites offer various functionality to the users accessing them. A user web experience can be understood as a journey. During a journey the user can access various web pages associated with one website, and also access web pages in other domains via the website, such as a payment web page in a different domain. A user may perform multiple journeys in the web browser of their computing equipment at the same time.

It is known to provide 3^{rd} party software applications which can be used to enhance the services provided by a website to users. The 3^{rd} party software applications may not be visible to the user as being provided by a 3^{rd} party.

An example of a 3^{rd} party software application is the provision of functionality on closure of a web page by a user. Rather than immediately closing the web page, on initiation of closure of the web page the 3^{rd} party software application may intervene and seek the user's confirmation that the closure of the web page should be enacted. Such techniques are known in the art to improve user engagement with websites.

However if a user, through a browser of their computing device, has multiple web pages open all associated with a single web journey, it may be disadvantageous to enable a 3^{rd} party software application on closure of every web page. In particular if the 3^{rd} party software application initiates a process to encourage the user to stay in the journey, it may be inappropriate to enable the 3^{rd} party software application if the user has other web pages open associated with the same journey (and also associated with the 3^{rd} party software application).

It is an aim of the invention to provide an improved technique.

### SUMMARY OF THE INVENTION

The invention provides a method of controlling activation of a software application associated with a web page on detection of initiation of closure of the web page, comprising: determining if another linked web page is associated with the software application; and in dependence thereon selectively enabling the software application.

The initiation of closure of the web page may be detected by detecting selection of a menu option to close the web page. The initiation of closure may also be detected by inferring exit intent, for example by tracking mouse movement and inferring exit intent by detecting mouse movement toward a menu bar or menu option having an exit option. The initiation of closure may be detected based on detected a ‘back’ operation, such as selection of a back button in a menu on a user interface, rather than selection of a specific exit button in a menu on a user interface.

If it is determined that there is not another linked web page associated with the software application, the software application may be enabled. If it is determined that there is another linked web page associated with the software application, the software application may not enabled.

The method may further comprise storing an association of linked web pages, which association identifies all software applications with which each linked web page is associated. The method may further comprise storing a copy of that association for each linked web page.

On detecting a request to close a web page, the stored association, or the copy of the stored association for that web page, may be accessed in order to selectively enable any application associated with that web page.

On detecting the request to close the web page the association may be updated.

On detecting the request to close the web page the copy of the association for the web page may be updated, the stored association may be updated based on the updated copy, and the copies for further web pages may be updated based on the update to the stored association.

The method may further comprise, on opening a web page associated with a software application, creating an iFrame for that web page.

The method may further comprise the step of creating an iFrame object for linked web pages, wherein the stored association is an iFrame object.

Each linked web page may be associated with one or more applications, each application being selectively enabled.

An application may be selectively enabled dependent on whether another application is enabled.

The method may further comprise: requesting a web page from a web server; on receipt of the web page, identifying a web server associated with a software application for the web page; requesting the software application from the web server; and receiving the software application.

When an item is utilised, the method may further comprise, responsive to the request for the software application from the web server, receiving instructions from the web server to create an iFrame in addition to receiving the software application. The method may further comprise loading the software application, and on completion of loading the software application updating the iFrame object. The iFrame object may stored in the browser cache, and copies of the iFrame object may be stored in association with each web page. On detecting closure of a web page, the iFrame object may be updated by de-registering the web page. It may be determined if the closed web page is associated with the last instance of a software application. If the web page is associated with a plurality of further software applications, the determining step may be performed for each further software application. Enabling the further software application may dependent on at least one further rule. The rules may define the frequency with which the further software application can be enabled. The rules define a time interval required for enablement of the further software application.

The method may further comprise the step of suspending the request to close the web page whilst the determining step is carried out.

The method may further comprise the step of, in dependence on the web page not being associated with the last instance of any further software application, allowing the request to close the web page.

There may be provided a method of controlling the closure of a web page at a browser, comprising: for each web page of a journey, delivered to the browser and being associated with a 3^{rd} party software application, creating an iFrame, there being an iFrame object identifying the created iFrames at the browser for the journey and an identity of at least one further software application associated with each iFrame or web page; on detecting a request to close a web page: determining if the web page is associated with the last instance of a further software application for the associated journey; in dependence on the web page being associated with the last instance of a further software application for the associated journey, enabling the further software application.

Aspects additionally provide a computer device configured to perform any described method. A computer device may be any one of a user device, a mobile device, a computer, a laptop computer; a tablet; or a mobile phone.

The invention also provides a computing device configured to detect initiation of closure of a web page, and comprising: a memory for storing an identity of the at least one web page and a software application associated with the web page; a processor configured to detect a request to close the web page, and configured to determine if another web page is linked to the web page and associated with the software application, and for selectively enabling the software application in dependence thereon.

The initiation of closure of a web page may be detected by detecting selection of a closure option, inferring an intent to close the web page (an intent to exit), or otherwise detecting closure of the web page such as detecting an operation to navigate backwards.

The processor may be configured, if it is determined that there is not another linked web page associated with the software application, to enable the software application, and if it is determined that there is another linked web page associated with the software application, to not enable the software application.

The memory may be a browser memory configured to store an association of linked web pages, which association identifies all software applications with which each linked web page is associated.

The computer device may be configured to store a copy of that association for each linked web page in a further memory location.

The processor may be configured to update the association stored in memory when closure of a web page is detected.

There is disclosed a method of controlling the closure of a web page at a browser, comprising: for each web page of a journey, delivered to the browser and being associated with a 3^{rd} party software application, creating an iFrame, there being an iFrame object identifying the created iFrames at the browser for the journey and an identity of at least one 3^{rd} party software application associated with each iFrame or web page; on detecting a request to close a web page: determining if the web page is associated with the last instance of a 3^{rd} party software application for the associated journey; in dependence on the web page being associated with the last instance of a 3^{rd} party software application for the associated journey, enabling the 3^{rd} party software application.

The method may further comprise, at a web server: requesting a web page from a web server; on receipt of the web page, identifying a web server associated with a 3^{rd} party software application for the web page; requesting the 3^{rd} party software application from the web server; and receiving the 3^{rd} party software application.

The method may further comprise, responsive to the request for the 3^{rd} party software application from the web server, receiving an instructions from the web server to create an iFrame in addition to receiving the 3^{rd} party software application.

The method may further comprise loading the 3^{rd} party software application, and on completion of loading the third party software application updating the iFrame object.

The iFrame object may be stored in the browser cache, and copies of the iFrame object are stored in association with each web page.

On detecting closure of a web page, the iFrame object may be updated by de-registering the web page.

It may be determined if the closed web page is associated with the last instance of a 3^{rd} party software application.

If the web page is associated with a plurality of 3^{rd} party software applications, the determining step may be performed for each 3^{rd} party software application.

Enabling the 3^{rd} party software application may be dependent on at least one further rule.

The rules may define the frequency with which the 3^{rd} party software application can be enabled.

The rules may define a time interval required for enablement of the 3^{rd} party software application.

The method may further comprise the step of suspending the request to close the web page whilst the determining step is carried out.

The method may further comprise the step of, in dependence on the web page not being associated with the last instance of any 3^{rd} party software application, allowing the request to close the web page.

There is disclosed a computing device configured to: for each web page of a journey, deliver to the browser and being associated with a 3^{rd} party software application, create an iFrame, there being an iFrame object identifying the created iFrames at the browser for the journey and an identity of at least one 3^{rd} party software application associated with each iFrame or web page; on detecting a request to close a web page: determine if the web page is associated with the last instance of a 3^{rd} party software application for the associated journey; in dependence on the web page being associated with the last instance of a 3^{rd} party software application for the associated journey, enable the 3^{rd} party software application.

The computing device may further be configured to: request a web page from a web server; on receipt of the web page, identify a web server associated with a 3^{rd} party software application for the web page; request the 3^{rd} party software application from the web server; and receive the 3^{rd} party software application.

The computing device may be configured to respond to the request for the 3^{rd} party software application from the web server, receive an instruction from the web server to create an iFrame in addition to receiving the 3^{rd} party software application.

The computing device may further be configured to load the 3^{rd} party software application, and on completion of loading the third party software application updating the iFrame object.

The computing device may further be configured to store the iFrame object in the browser cache, and copies of the iFrame object are stored in association with each web page.

The computing device may further be configured to, detect closure of a web page, update the iFrame object by de-registering the web page.

The computing device may further be configured to determine if the closed web page is associated with the last instance of a 3^{rd} party software application.

The computing device may further be configured, if the web page is associated with a plurality of 3^{rd} party software applications, to carry out the determination for each determine performed for each 3^{rd} party software application.

The computing device may further be configured to enable the 3^{rd} party software application is dependent on at least one further rule.

The computing device may further be configured such that rules define the frequency with which the 3^{rd} party software application can be enabled.

The computing device may further be configured such that the rules define a time interval required for enablement of the 3^{rd} party software application.

The computing device may further be configured such that the request to close the web page is suspended whilst the determining step is carried out.

The computing device may further be configured such that, in dependence on the web page not being associated with the last instance of any 3^{rd} party software

### BRIEF DESCRIPTION OF THE FIGURES

There is further described arrangements with reference to the accompanying drawings, in which:

FIG. 1 is a general network illustration of client computing devices and web servers in which web pages are displayed to users at browsers associated with the computing devices;

FIG. 2 is an exemplary illustration of the connection between a web server providing a website which is accessed by a browser of a computing device, which web server service is enhanced by the provision of services from a third party software application;

FIG. 3 illustrate iFrames created in combination with web pages generated for a browser;

FIG. 4 illustrate examples of an iFrame Object;

FIG. 5 illustrates the maintenance of an iFrame Object and the creation of iFrames for multiple web pages and multiple journeys in a single browser;

FIG. 6 illustrates an example process for creating iFrames and adjusting iFrame objects on opening of web pages;

FIG. 7 illustrates the relationship between web pages and iFrames, and the iFrame object and the allocation of copies to iFrames;

FIG. 8 illustrates an exemplary process for selectively enabling a third party software application on closure of a web page; and

FIG. 9 illustrates an exemplary computing device configured to perform the described processes.

### DESCRIPTION OF THE PREFERRED ARRANGEMENT

The following makes reference to non-limiting examples and exemplary arrangements, which are referred to for the purpose of understanding.

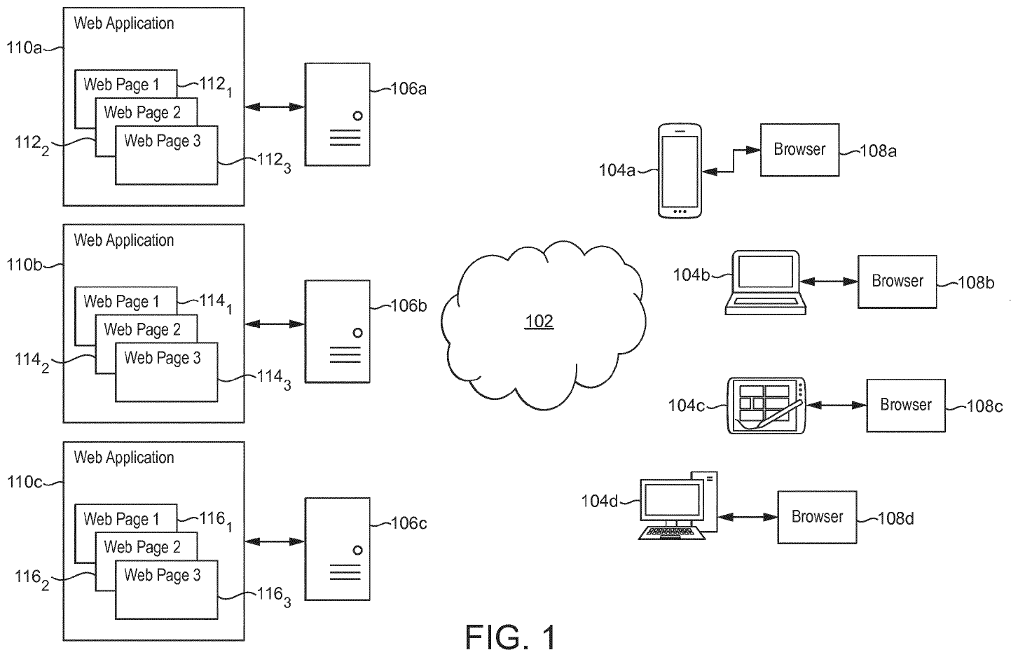

FIG. 1 shows a high level system architecture 100 consisting of client-side computing devices 104a, 104b, 104c, 104d capable of communicating with web servers 106a, 106b, 106c via a network 102.

The examples of client-side computing devices shown are a smart phone 104a, a laptop computer 104b, a tablet 104c, and a desktop computer 104d. A selection of computing devices are shown to illustrate that the present technology may operate with different client-side computing devices. The system may include client-side computing devices in addition to or instead of those shown.

Each computing device 104a to 104d may include a browser application, or browser, respectively identified by respective reference numerals 108a to 108d. The operation of browsers are known, but in general the computing devices 104a to 104d each run a version of a browser as part of their operating system, capable of accessing and retrieving web pages from web servers such as servers 106a to 106c. The browser on each computing device retrieves an electronic document, or web page, from a web site, i.e. one of web servers 106a to 106c, and displays the web page on a monitor or other output device associated with it.

To view the electronic document as a web page, the user specifies a URL (Uniform Resource Locator) identifying the particular document in the browser. A URL may be specified by entering a URL character string using a user interface, by selecting a hyperlink specifying the URL in a HTML (HyperText Markup Language) document currently being displayed in the browser, or by selecting a hyperlink from a list provided by the browser. In response to the entered URL, the browser generates a request command for the URL and transmits the request over the network to fetch the documents using conventional internet protocols, such as HTTP (Hypertext Transfer Protocol).

Servers 106a to 106c are computing devices configured to host web pages. Each web page is rendered as a part of a web application 110a to 110c, which comprise respective web pages. Illustrated are three web applications 110a to 110b each shown as having three web pages: 112₁ to 112₃; 114₁ to 114₃; and 116₁ to 116₃ respectively. Each web application 110a to 110c may have a single web page or multiple web pages, and the illustration of three web pages is not limiting. While three web servers are shown, the present technology may operate with a single server or more than two servers. A single server may host web pages from one or more web applications, some or all of which may collaborate with each other. Web applications which cooperate with each other may be spread across different servers.

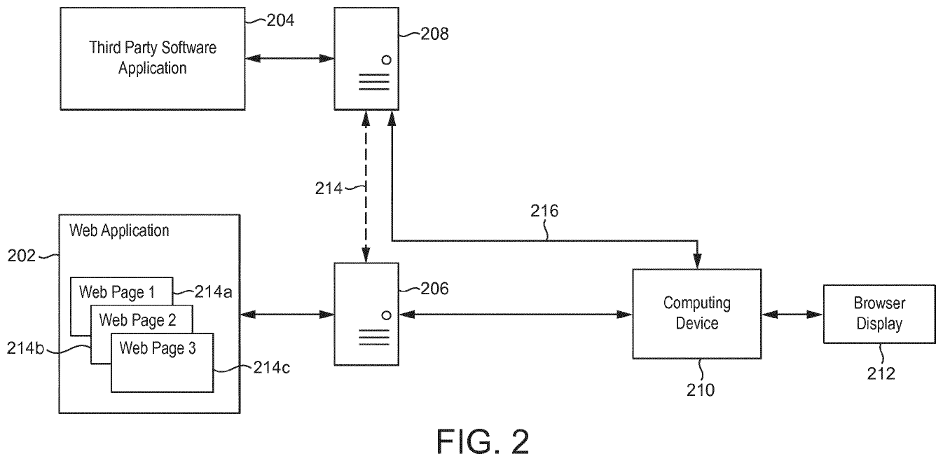

FIG. 2 illustrates an arrangement in which a 3^{rd} party software application is provided to a website, to offer additional functionality to a user when browsing the website. The website is associated with a web application 202 hosted by a server 206, and includes a plurality of web pages denoted by reference numerals 214a to 214c. The 3^{rd} party software application 204 is hosted by a server 208.

A bi-directional dashed line 214 indicates a communication between the servers 206 and 208, which communication establishes a relationship between the web application and the 3^{rd} party application at some time prior to delivery of a web page. The 3^{rd} party application can provide additional 3^{rd} party services to the offerings of the web application based on an agreement between the 3^{rd} party application and the web application. The communication between the servers 206 and 208 may be provided by a network such as the Internet.

A computing device 210 associated with a user is in communication with the server 206 to access the website associated with the web application 202. A bi-directional line 218 indicates communication between the server 206 and the computing device 210, which may be provided by a network such as the Internet. The computing device 210 is associated with a browser, with a browser display 212 displaying the browser to the user (or client), for example using a display of the computing device 210.

The browser associated with the computing device 210 makes a request for a web page from the server 206 by sending a request on communication line 218. In response thereto, the server 206 returns an associated web page to the computing device 210 for display by the browser in browser display 212.

The web page delivered by the server 206 to the computing device 20 includes control scripts. In this example it is assumed that the web application 202 is associated with the 3^{rd} party software application 204. These scripts will therefore include instructions relating to the 3^{rd} party software application as it is to be used in conjunction with the delivered web page.

In the present example, it is assumed that the web page is associated with the 3^{rd} party application 204, and the delivered web page includes an instruction to the computing device 210 to fetch additional information from the 3^{rd} party software application 204. Thus on receipt of the web page, the computing device 210 additionally communicates with the server 208 on a bi-directional communication line 216 to retrieve the 3^{rd} party application (or applications) associated with the web page. The communication between the server 208 and the computing device 210 may be provided by a network such as the Internet.

An example of a service which the 3^{rd} party software application may provide is to detect when a user initiates closure of a page of the website associated with the web application, and rather than to allow the immediate closure of that page to instead launch an instance of a service associated with the 3^{rd} party software application. This may be, for example, to generate a message for display to the use to prompt them to confirm that they wish to leave the web page, and may for example comprise offering a voucher to the user if they choose to stay on the web page rather than exit. This is an example of a service which may be offered by the 3^{rd} party software application, but the service offered is non-limiting.

A user may conduct a journey in accessing a web site. A journey refers to a user's web experience, which may involve the client opening and closing web pages. During the journey the client may access domains other than the domain of the website they are viewing, for example in order to pay for a purchase they are making from a website. During this journey the user may open multiple pages associated with the same website in their browser, and web pages of other websites to which they are directed.

The closure of one web page does not necessarily mean that the user has finished their journey. They may for example have other pages open associated with the website, or other pages open from which they have been directed to by the website and link in to their journey. The closure of one page for the website may therefore still mean that at least one other (or multiple other) pages of the website, or more generally at least one other page associated with the same journey, are still open in the user browser.

It may be desirable for the service associated with a 3^{rd} party software application to be launched only on the closure of the last web page associated with a journey having the 3^{rd} party software application associated with it, and not on the closure of every page with which it is associated. It may be inappropriate to launch the service associated with the 3^{rd} party software application on the closure of every page, since the user may still on the closure of the web page have other pages associated with the journey open in the browser. Where a 3^{rd} party software application is, for example, to display a query as to whether the user is sure they want to leave, it may only be appropriate to do so if on leaving the page they would be ending their journey.

In accordance with the described technique, it may be configured such that the service associated with the 3^{rd} party software application is launched only on closure of the last web page of the journey associated with the 3^{rd} party software application, i.e. when the closure of the web page would finish the journey in the browser. In some implementations, the journey may be restricted to a website, and thus the closure of the final page of the website may indicate the end of the journey.

In arrangements, some but not all of the web pages may be associated with the 3^{rd} party software application, such that there are some web pages of a website which may not be associated with the 3^{rd} party application. Thus in accordance with the described technique, the service associated with the 3^{rd} party software application is launched only on closure of the last web page associated with a journey which is also associated with the 3^{rd} party software application, i.e. when the closure of the web page would close the last page of the journey in the browser which is associated with the 3^{rd} party software. On closure of such a webpage the journey may still be ongoing, but none of the remaining open pages are associated with that 3^{rd} party software application.

An improvement is thus described in order to allow the enablement of a 3^{rd} party software application to be controlled.

In an example the improvement creates an iFrame (Inline Frame) for each web page of a web site associated with a web application which a browser of a computing device opens. An iFrame is a HTML document embedded in another HTML document on a website. Typically an iFrame may be used in a variety of ways to enhance the user experience. The created iFrame is not visible to a user. In general, an iFrame is a global context. Another example of a global context is a pop-up window.

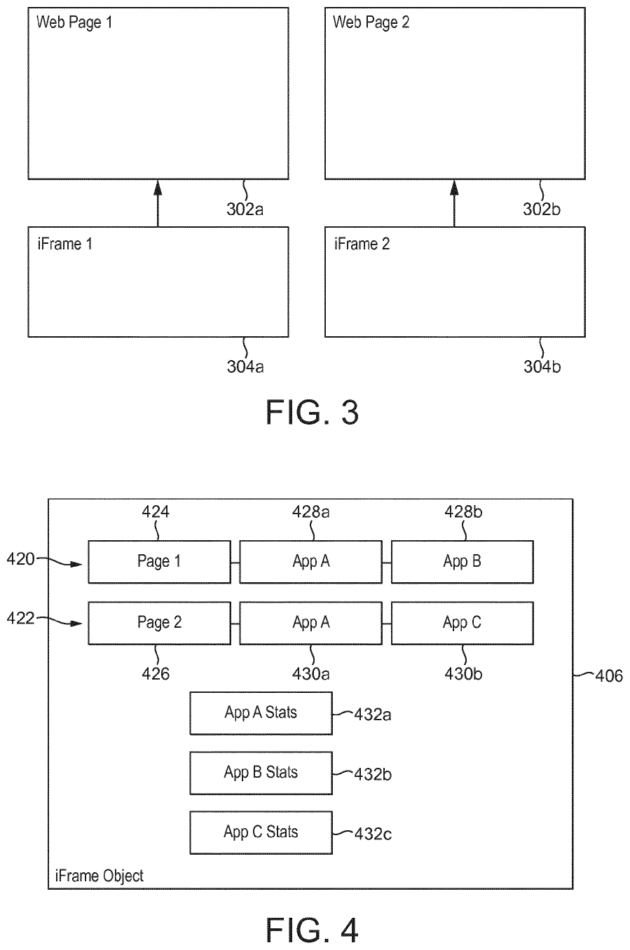

In accordance with this improvement, on retrieval of a web site page, an iFrame is created for that page. FIG. 3 illustrates this further.

As shown in FIG. 3 a first web page 302a and a second web page 302b are open within the same journey. An iFrame has been opened for each web page, and thus associated with each web page is an iFrame, denoted in FIG. 3 by reference numerals 304a and 304b respectively.

In the preferred arrangement an iFrame is created for every web page. In alternative arrangements an iFrame may only be opened for a web page if the web page is associated with a third party application. In general, for the preferred arrangement, it can be understood that there may be provided n iFrames for n web pages for a given journey.

As is discussed further hereinbelow, the iFrame is associated with an Object for the journey with which the web page is associated. The associated Object is used to identify the number of web pages that are open for the journey with which the web page is associated, and the type and number of 3^{rd} party software applications associated with each web page. One such iFrame Object is provided per journey.

As web pages are opened and closed, the iFrame Object of the associated iFrames are updated. The iFrame Object is used to determine, on closure of a web page, whether the web page is the last open web page within that journey for a given 3^{rd} party software application. The 3^{rd} party software application may then be enabled prior to the web page being closed.

This is illustrated further with respect to FIG. 4, which illustrates an example of an iFrame Object.

With reference to FIG. 4, in a preferred arrangement an iFrame Object 406 is configured to identify each open iFrame, and consequently each open web page, associated with a given journey of a client. For each open iFrame (corresponding to a web page), the iFrame Object also identifies any 3^{rd} party applications associated with that web page. Thus, with further reference to FIG. 4, there is illustrated a parameter 420 identifying the first iFrame (and consequently the first web page), and a parameter 422 identifying the second iFrame (and consequently the second web page). For each parameter there is provided an identification of the 3^{rd} party applications associated with a page. Thus parameter 420 identifies “Page 1” in field 424, and identifies “App A” and “App B” in field 428a and 428b as being associated with that page. Parameter 422 identifies “Page 2” in field 426, and identifies “App A” and “App C” in fields 430a and 430b as being associated with that page. “App A”, “App B”, and “App C” are names of three exemplary 3^{rd} party software applications.

The iFrame Object 406 may also include information such as when a particular 3^{rd} party application was last initiated, how many times it has been initiated etc. Thus in FIG. 4 the iFrame Object 406 is shown as including: a parameter 432a identifying the statistics for App A, referred to as “App A Stats”; a parameter 432b identifying the statistics for App B, referred to as “App B Stats”; and a parameter 432c identifying the statistics for App C, referred to as “App C Stats”.

Each time a web page of the journey is closed a determination is made as to whether this is closure of the last page associated with a particular 3^{rd} party software application. This may also involve accessing the statistics for any application associated with the web page being closed, for example to ensure that an application is not initiated more than a certain number of times, or is not initiated within a certain time distance of a previous initiation.

Each time a web page of the journey is opened or closed, an appropriate modification is made to the iFrame Object to add or delete page information.

The arrangement of an iFrame Object as shown in FIG. 4 is illustrative, and arrangements may vary. For example, in an alternative, rather than listing the web pages and their associated applications, there may be listed the applications and the pages they are active on.

In a modification of this arrangement, an iFrame Object may only be created if at least one web page of a given journey is associated with at least one 3^{rd} party application. A page may not be listed within an iFrame Object if it is not associated with a 3^{rd} party application.

The iFrame Object is updated each time a web page is opened or closed for the given journey as noted above. When the number of 3^{rd} party applications associated with an open web page is identified as 1, and closure of the web page associated with that 3^{rd} party application is initiated, then the associated 3^{rd} party application is preferably enabled prior to closure of the web page.

For example, referring to FIG. 4, if web page ‘Page 1’ is disclosed, it will be determined that another page associated with

‘App A’ is still open (‘Page 2’), and no action is required in respect of ‘App A’. However this is the last open page associated with ‘App B’, and therefore ‘App B’ is initiated.

The 3^{rd} party application is thus preferably enabled when the last web page of a given journey associated with that 3^{rd} party application is closed. This is implementation dependent, and may be configurable. For example, it may be that a particular application can over-ride this process. It may be that the 3^{rd} party application can only be shown a certain number of times. It may be that there must be a fixed time interval, e.g. 15 minutes, between instances of the 3^{rd} party application being enabled.

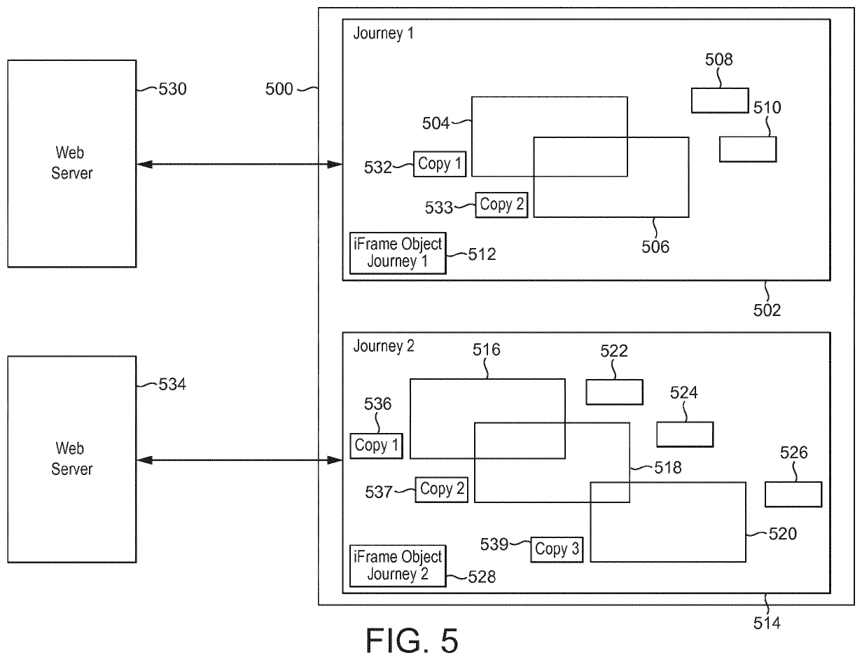

A client may have multiple journeys simultaneously, and thus there may be multiple iframe Objects associated with a single client, with one iFrame Object per journey. This can be further understood with reference to FIG. 5, which illustrates a scenario of a client having multiple journeys.

A browser denoted by reference numeral 500 is operating on a client device. In the illustrated example two journeys are operating within the browser on the client device, a first journey denoted by reference numeral 502 and a second journey denoted by reference numeral 514.

In the first journey as denoted by reference numeral 502 the client has two web pages 504 and 506 open. Associated with each web page 504, 506 is a respective iFrame 508, 510. Also associated with the first journey is an iFrame Object 512. A ‘local’ copy of this iframe Object, respectively denoted 532, 533, is stored locally with each web page 504, 506.

In the second journey as denoted by reference numeral 514 the client has three web pages 516, 518 and 520 open. Associated with each web page 516, 518, 520 is a respective iFrame 522, 524, 526. Also associated with the second journey is an iFrame Object 528. A ‘local’ copy of this iFrame Object, respectively denoted 536, 537, 539 is stored locally with each web page 516, 518, 520.

The first journey 502 is facilitated by access to a web server 530.

The second journey 514 is facilitated by access to a web server 534.

Each journey may be associated with a unique identification (ID) tag, which is unique to the journey. Each web page delivered to a browser may have the journey ID included in it. The browser preferably does not keep a track of the journey, and the journey ID tag in a delivered web page allows the web page to be associated with a journey.

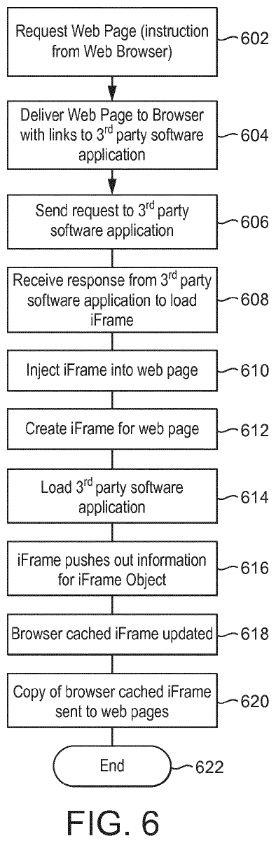

FIG. 6 describes the process invoked for creating and updating an iFrame Object on opening of a web page.

In a step 602 a request is made for a web page at a server from a client-side computing device. The request is generated from the client-side computing device to a web server responsive to an instruction from a web browser running on the client-side computing device.

Following the request, in a step 604 a web page is delivered to the browser, and the web page is displayed on a display associated with the browser, or other appropriate output associated with the browser. The web page is delivered from the web server to the client-side computing device.

As noted above, the delivered web page optionally includes scripts which identify links to any 3^{rd} party software applications for the delivered web page.

In a step 606 the browser sends a message to any identified 3^{rd} party software application, such as (with reference FIG. 2) sending a message to the web server 208.

In a step 608 the 3^{rd} party software application sends a response to the browser, which preferably includes an instruction to create an iFrame and associate it with the web page.

In a step 610, the iFrame Object is injected into the web page. This creates an association between the web page and the iFrame.

In step 612 the creation of the iFrame then happens locally on the browser. A local copy of the iFrame Object is created, such as copy 532, and stored alongside the web page. The contents of the iFrame are loaded from the web server of the 3^{rd} party software application.

In a step 614, the 3^{rd} party software application for the web page is loaded.

In a step 616, the local copy of the iFrame Object pushes out it's information to update the iFrame Object such as iFrame Object 512. The iFrame information is pushed out to the iFrame Object in the browser cache, and the iFrame Object in the browser cache is updated in step 618, and then a copy of the updated iFrame object sent out to be held locally by each web page in step 620.

There is thus a central iFrame Object held in the browser cache of the device, and local copies of the iFrame Object which are stored locally with each web page in the device.

The process then ends as denoted by step 622. The steps 610 to 620 may be performed in any order, and are asynchronous.

In general, there will be a master iFrame object for each journey, and then a copy of this master iFrame object will be provided for each web page associated with the master. The copy of the master iFrame object will be held in each web page. These copies of the master iFrame object may be referred to as slave iFrame objects.

If a page is updated, then the page tells the master iFrame object, and then the master iFrame object will notify the update to each of the other copies. Thus in general when any update occurs to a web page, the web page updates its own local slave copy of the iFrame object, this update is then notified to the master iFrame object which is also updated, and then other slave copies of the iFrame object are notified by the master.

Local slave copies of the iFrame object, associated with each web page, are necessary for quick access when a user leaves a page. When a user leaves a page synchronous access is required. However local slave copies of the iFrame object may not be required for any other scenarios. The local slave copies allow the information in the iFrame Object to be accessed quickly.

The location of the iFrame Object, and the generation and location of any copies, will be implementation dependent. The purpose of the iFrame Object is to enable a determination to be made as discussed above with reference to FIG. 4. The location and the generation of copies is dependent on requirements for speed of access to the information, and may vary from implementation to implementation. In some implementations no copy may be required.

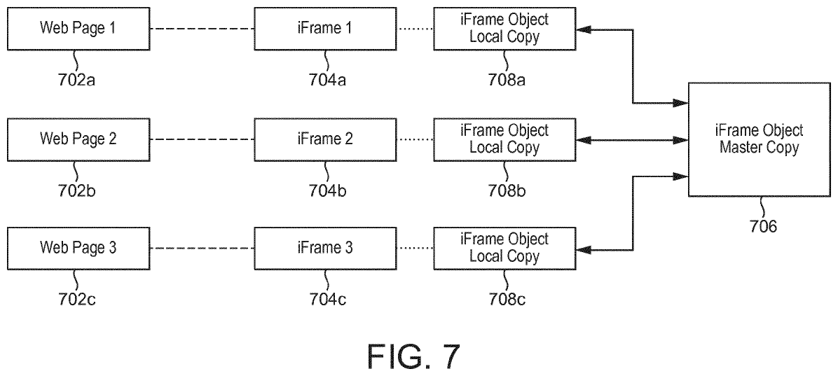

FIG. 7 illustrates the architecture created with the use of iFrames in accordance with the described example. In the example of FIG. 7 there is shown a journey comprising three open web pages, labelled 702a, 702b, and 702c. Each web page is associated with a respective iFrame 704a, 704b, 704c.

An iFrame Object 706, consistent with iFrame Object of FIG. 4, is stored in the browser cache and holds details for the journey as described. The iFrame Object 706 may be stored in the browser cache.

Copies 708ₐ, 708_{b} and 708_{c} of the iFrame Object 706 are stored locally for each of the iFrames 704ₐ, 704_{b} and 704_{c}. Each copy 708ₐ, 708_{b} and 708_{c} is in communication with the master iFrame Object 706. Thus the local copies may be communicated to the master, and the master may distribute any update retrieved from a local copy. The local copies can be readily accessed, more readily than the master copy when a web page is about to be exited.

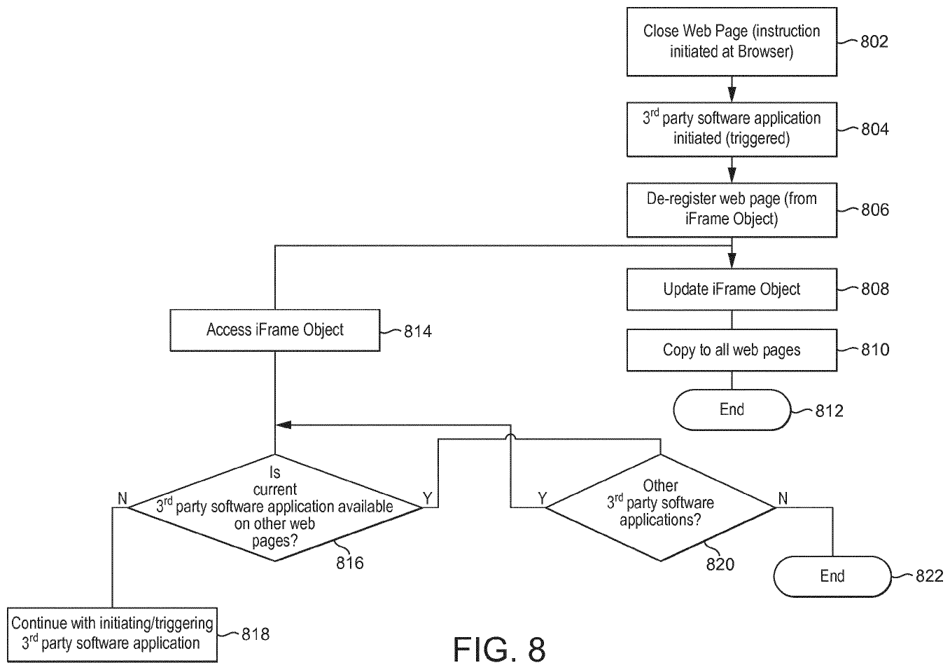

FIG. 8 describes the process invoked for updating an iFrame Object and initiating a 3^{rd} party software application on closing of a web page.

In a step 802 a request is made to close a web page at a server from a client-side computing device.

In a step 804 a 3^{rd} party software application associated with that web page is initiated.

In a step 806 the page is then de-registered. The local copy of the iFrame Object is then updated.

In a step 808 the update to the local copy is copied to the master iFrame Object. A copy of the updated master iFrame Object is then provided to each web page as above, and as denoted by step 810. As denoted by step 812, the process for updating the iFrame Object is then closed.

Following step 806, in a step 814 it is determined whether a 3^{rd} party software application is to be triggered. This involves determining if an application associated with the closed web page is associated with any other web pages.

In one example, a determination is made based on the local copy of the iFrame Object for the closed web page. This local copy of the iFrame Object may provide information as to which applications are associated with the closed web page, and also whether any application is associated with any other web pages. Thus sufficient information can be obtained from this local copy of the iFrame Object to make a determination as to whether to trigger a 3^{rd} party application.

Other examples are possible, and for example a determination may be made on the master copy of the iFrame Object, and may be made on an assessment of the iFrame Object either before or after it is updated on closure of the web page. In general an ‘old’ copy of the iFrame object can be looked at or an updated copy.

Preferably the local copy of the iFrame Object before it is updated is assessed.

If an application associated with the web page being closed is identified as not being associated with any other web page, therefore the last web page associated with the 3^{rd} party software application is being closed. In step 818 the 3^{rd} party software application is enabled.

Step 816 generally denotes that a determination is made as to whether to trigger the 3^{rd} party software application based on an assessment of the iFrame Object or a copy of it.

If it is identified that the 3^{rd} party software application is associated with other web pages which remain open, then in step 820 it is determined whether there are any further software applications associated with the closed web page. If there are, then step 816 is repeated for each further 3^{rd} party software application. If not, then in a step 822 the process ends.

If in step 816 it is determined that the web page being closed is the last web page associated with a particular 3^{rd} party application, then in step 818 that 3^{rd} party software application is triggered or initiated.

If it is determined to keep a web page open after running the 3^{rd} party software application, the above technique may not be further applied for that web page on the basis it has already run one.

In the foregoing it is set out that web pages are identified having a common domain. This assumes that a website is identifiable by association with a domain, and the domain identifies the website. Any technique for identifying web pages as being associated with a common website is appropriate.

In the foregoing it is set out that web pages are identified as being associated with a third party software application. In practice a web page may be associated with none, one, or more than one third party software applications. The described technique is concerned with enabling a third party software application when the last web page for a given domain and associated with that third party software application closes. The web page may be associated, in such circumstances, with more than one third party software application, and more than one third party software application may be enabled. The more than one third software application may comprises multiple applications associated with one third party, or multiple third parties each providing one or more software applications.

A computer device configured to perform any described method preferably includes a processor and memory. Any browser and browser history is stored in memory, and the memory is updated by a processor. The computer device is provided with an interface to a user.

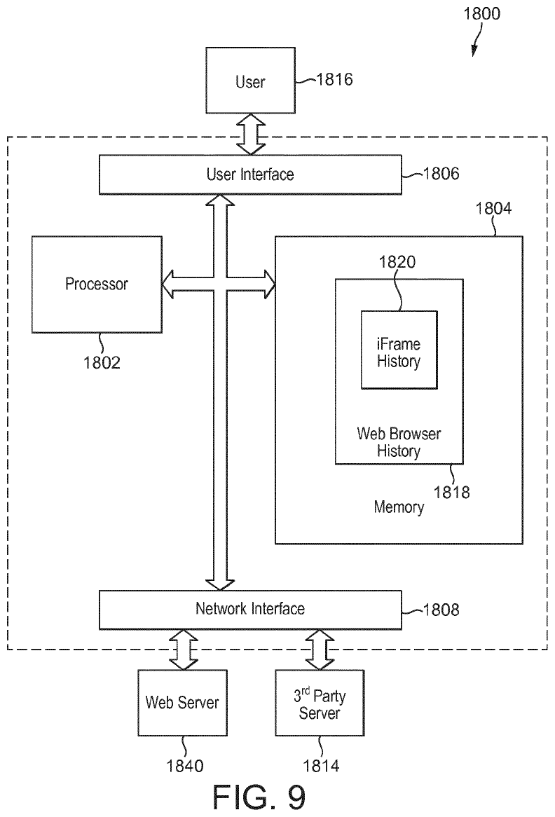

An exemplary computing device 1800 is illustrated in FIG. 9. The computing device includes a user interface 1806, a processor 1802, a memory 1804, and a network interface 1808, all interconnected by communication lines of the computing device.

The user interface 1806 provides an interface to a user 1816.

The network interface 1808 provides an interface t a web server 1840 and 3^{rd} party server 1814.

The memory 1804 includes a storage 1818 for a web browser history, including a storage 1820 for an optional iFrame history. Parts of the memory may be provided in different locations of the device, or may be accessed differently within the device.

Reference is made herein to a journey. It will be understood that in a journey various websites are linked or have a common association.

In the described examples an iFrame is utilised. However examples are not limited to the use of an iFrame (or an iFrame Object).

Examples also refer to initiating the further software application on the basis that closure of the the last web page associated with that application is detected. There may be other scenarios where it is desirable to check the number of web pages associated with an application. For example, in other techniques an intended closure of a web page is inferred by detecting the mouse movement toward a web page menu. In such case the detection to infer exit may be conditional on the web page being the last web page open and associated with a particular application. Similarly for other techniques associated with detecting closure of a web page, for example techniques associated with detected a back operation by use of a ‘back button’, the triggering of an application such as a 3^{rd} party software application may be additionally dependent on detecting that the web page which is being navigates back from is the last web page associated with the application.

In the foregoing description it is described that a 3party software application is provided, the 3^{rd} party being a party additional to the user and the party providing the website. However the party providing the website may also provide this ‘3^{rd} party’ software application, in which case there is no 3^{rd} party. In general terms, therefore, there is provided an additional software application, which may be provided by a 3^{rd} party, or may be provided by the party providing the website. There is no limitation as to where the further application providing the functionality described herein is provided from.

The methods to achieve the described functionality may be implemented as software processes. The software processes described may be implemented on a user device, such as a user computer, user laptop, user tablet, or user smartphone, any of which may be a user mobile device—in general any user device. Such a user device implementing such a process is preferably configured to access a network to allow the user device to load a website, and to allow the user device to access 3^{rd} party software applications associated with the website.

The software processes may be implemented by computer program code. The computer program code may be stored on a user device, or stored accessible to a user device. A computer program product may store computer program code which, when executed, performs a described method. A computer program may comprise code which when executed performs any described method. The computer program code may be transmitted to a new device for execution.

The foregoing has set out examples to assist in understanding the invention. The invention is not limited by the details of any example given, nor is the invention limited to any combination of features described.

1. A method of controlling activation of a software application associated with a web page on initiation of closure of the web page, comprising:
determining if another linked web page is associated with the software application; and
in dependence thereon selectively enabling the software application.

2. The method of claim 1 wherein if it determined that there is not another linked web page associated with the software application, the software application is enabled.

3. The method of claim 1 wherein if it is determined that there is another linked web page associated with the software application, the software application is not enabled.

4. The method of claim 1 further comprising storing an association of linked web pages, which association identifies all software applications with which each linked web page is associated.

5. The method of claim 4 further comprising storing a copy of that association for each linked web page.

6. The method of claim 4 wherein on detecting a request to close a web page, the stored association, or the copy of the stored association for that web page, is accessed in order to selectively enable any application associated with that web page.

7. The method of claim 4 wherein on detecting the request to close the web page the association is updated.

8. The method of claim 5 wherein on detecting the request to close the web page the copy of the association for the web page is updated, the stored association is updated based on the updated copy, and the copies for further web pages are updated based on the update to the stored association.

9. The method of claim 1 further comprising, on opening a web page associated with a software application, creating an iFrame for that web page.

10. The method of claim 9 further comprising the step of creating an iFrame object for linked web pages, wherein the stored association is an iFrame object.

11. The method of claim 1 wherein each linked web page is associated with one or more applications, each application being selectively enabled.

12. The method of claim 11, wherein an application is selectively enabled dependent on whether another application is enabled.

13. A computer program product for storing computer program which, when executed on a computer, performs the method of claim 1.

14. A computer program which, when executed on a computer, performs the method of claim 1.

15. A computing device configured to detect initiation of closure of a web page, and comprising:
a memory for storing an identity of the at least one web page and a software application associated with the web page;
a processor configured to detect initiation of closure of the web page, and configured to determine if another web page is linked to the web page and associated with the software application, and for selectively enabling the software application in dependence thereon.

16. The computing device of claim 15 wherein the processor is configured, if it is determined that there is not another linked web page associated with the software application, to enable the software application, and if it is determined that there is another linked web page associated with the software application, to not enable the software application.

17. The computing device of claim 15 wherein the memory is a browser memory configured to store an association of linked web pages, which association identifies all software applications with which each linked web page is associated.

18. The computer device of claim 17 configured to store a copy of that association for each linked web page in a further memory location.

19. The computer device of claim 17 wherein the processor is configured to update the association stored in memory when closure of a web page is detected.

20. The method of claim 5 wherein on detecting a request to close a web page, the stored association, or the copy of the stored association for that web page, is accessed in order to selectively enable any application associated with that web page.
